(19) United States
(12) Patent Application Publication
(10) Pub. No.: US 2022/0156102 A1
(43) Pub. Date: May 19, 2022

(54) SUPPORTING UNMODIFIED APPLICATIONS IN A MULTI-TENANCY, MULTI-CLUSTERED ENVIRONMENT

(71) Applicant: DIAMANTI, INC., San Jose, CA (US)

(72) Inventors: Sambasiva Rao Bandarupalli, Fremont, CA (US); Kshitij Gunjikar, Fremont, CA (US)

(21) Appl. No.: 17/525,076

(22) Filed: Nov. 12, 2021

Related U.S. Application Data
(60) Provisional application No. 63/114,295, filed on Nov. 16, 2020.

(51) Int. Cl. G06F 9/455; H04L 61/30; H04L 9/40; G06F 9/50

(52) U.S. Cl. CPC G06F 9/45558; H04L 61/30; H04L 63/101; G06F 2009/4557; G06F 9/5077; G06F 2209/505; G06F 2009/45595; H04L 63/102

(57) ABSTRACT

Embodiments of the disclosure provide systems and methods for supporting unmodified applications on a tenant cluster in a multi-tenant, multi-cluster environment. According to one embodiment, a method for supporting unmodified applications in a multi-tenant, multi-cluster environment can comprise creating, in the multi-tenant, multi-cluster environment, a tenant cluster executing one or more applications. The tenant cluster and the one or more applications executing on the tenant cluster can be adopted by a domain cluster of the multi-tenant, multi-cluster environment without modification to the one or more applications for execution in the multi-tenant, multi-cluster environment. The tenant cluster and the one or more applications executing on the tenant cluster can then be managed by the domain cluster of the multi-tenant, multi-cluster environment.

### CROSS REFERENCE TO RELATED APPLICATION

The present application claims the benefits of U.S. Provisional Application Ser. No. 63/114,295, filed Nov. 16, 2020, entitled “Method and System for Managing Cloud Resources”, the entire disclosure of which is hereby expressly incorporated by reference in its entirety.

### FIELD OF THE DISCLOSURE

Embodiments of the present disclosure relate generally to methods and systems for multi-tenant cloud computing and more particularly to supporting unmodified applications on a tenant cluster in a multi-tenant, multi-cluster environment.

### BACKGROUND

A computer cluster is a set of computers that work together so that they can be viewed as a single system. Cloud-based computer clusters typically provide Platform-as-a-Service (PaaS), Infrastructure-as-a-Service (IaaS), and storage, and other services to tenants. A tenant is a group of users who share a common access with specific privileges to computing resources as may be available on a cluster or across multiple clusters in a multi-clustered environment. Multiple tenants can occupy a clustered or multi-clustered environment. Typically, when a tenant cluster is added to such an environment, existing applications executing on that cluster must be modified to execute within and be managed by the environment. Such modification are time consuming and can be error-prone. Hence, there is a need for methods and systems for supporting unmodified applications on a tenant cluster in a multi-tenant, multi-cluster environment.

### BRIEF SUMMARY

Embodiments of the disclosure provide systems and methods for supporting unmodified applications on a tenant cluster in a multi-tenant, multi-cluster environment. According to one embodiment, a method for supporting unmodified applications in a multi-tenant, multi-cluster environment can comprise creating, in the multi-tenant, multi-cluster environment, a tenant cluster executing one or more applications. The tenant cluster and the one or more applications executing on the tenant cluster can be adopted by a domain cluster of the multi-tenant, multi-cluster environment without modification to the one or more applications for execution in the multi-tenant, multi-cluster environment. The tenant cluster and the one or more applications executing on the tenant cluster can then be managed by the domain cluster of the multi-tenant, multi-cluster environment. In some cases, the multi-tenant, multi-cluster environment can comprise a Kubernetes environment, for example.

Adopting the tenant cluster and the one or more applications executing on the tenant cluster can comprise installing, by the domain cluster, on the tenant cluster, one or more management software components of the multi-tenant, multi-cluster environment. One or more default projects can be created, by the domain cluster, on the tenant cluster and one or more roles and one or more role bindings can be created, by the domain cluster, for the one or more default projects. The domain cluster can spawn a Hierarchical Namespace Controller (HNC) and a webhook on the tenant cluster. The webhook can comprise a listener for the one or more applications. The domain cluster can detect an existing user namespace on the tenant cluster and generate, on the tenant cluster, one or more custom resources in the detected user namespace. The created one or more roles and one or more role bindings for the created default projects can be propagated to the generated one or more custom resources by the domain cluster. Resource utilization information for the generated one or more custom resources can then be received, by the domain cluster, from the tenant cluster, during execution of the one or more applications on the tenant cluster.

Additionally, or alternatively, one or more multi-namespace projects can be implemented on the tenant cluster by the domain cluster. Implementing the one or more multi-namespace projects on the tenant cluster can comprise spawning, on the tenant cluster, an application in the detected user namespace of the tenant cluster. The spawned application on the tenant cluster can be detected by the domain cluster through the webhook on the tenant cluster. One or more roles and one or more role bindings for the detected, spawned application can be propagated to the tenant cluster by the domain cluster. A set of Role-Based Access Control (RBAC) rules for the detected, spawned application can be managed, by the domain cluster, based on the propagated one or more roles and one or more role bindings.

Additionally, or alternatively, the one or more applications executing on the tenant cluster can be reconciled by the domain cluster. Reconciling the one or more applications executing on the tenant cluster can comprise receiving, by the domain cluster, from the tenant cluster, configuration information for the one or more applications executing on the tenant cluster. A determination can be made by the domain cluster as to whether an application of the one or more applications executing on the tenant cluster has been newly created based on the configuration information for the one or more applications. In response to determining an application of the one or more applications executing on the tenant cluster has been newly created, the newly created application can be represented, by the domain cluster, in the configuration information for the one or more applications executing on the tenant cluster. Another determination can be made by the domain cluster as to whether an application of the one or more applications executing on the tenant cluster has been deleted from the tenant cluster based on the configuration information for the one or more applications. In response to determining an application of the one or more applications executing on the tenant cluster has been deleted from the tenant cluster, the configuration information for the deleted application can be cleaned up by the domain cluster.

According to another embodiment, a multi-tenant, multi-cluster environment can comprise a domain cluster communicatively coupled with each of a plurality of tenant clusters. The domain cluster can comprise a processor and a memory coupled with and readable by the processor and storing therein a set of instructions which, when executed by the processor, causes the processor to adopt a created tenant cluster and one or more applications executing on the tenant cluster without modification to the one or more applications for execution in the multi-tenant, multi-cluster environment and manage the tenant cluster and the one or more applications executing on the tenant cluster.

Adopting the tenant cluster and the one or more applications executing on the tenant cluster can comprise installing, by the domain cluster, on the tenant cluster, one or more management software components of the multi-tenant, multi-cluster environment. One or more default projects can be created, by the domain cluster, on the tenant cluster and one or more roles and one or more role bindings can be created, by the domain cluster, for the one or more default projects. The domain cluster can spawn an HNC and a webhook on the tenant cluster. The webhook can comprise a listener for the one or more applications. The domain cluster can detect an existing user namespace on the tenant cluster and generate, on the tenant cluster, one or more custom resources in the detected user namespace. The created one or more roles and one or more role bindings for the created default projects can be propagated to the generated one or more custom resources by the domain cluster. Resource utilization information for the generated one or more custom resources can then be received, by the domain cluster, from the tenant cluster, during execution of the one or more applications on the tenant cluster.

The instructions can additionally, or alternatively, cause the processor to implement one or more multi-namespace projects on the tenant cluster. Implementing the one or more multi-namespace projects on the tenant cluster can comprise spawning, on the tenant cluster, an application in the detected user namespace of the tenant cluster. The spawned application on the tenant cluster can be detected by the domain cluster through the webhook on the tenant cluster. One or more roles and one or more role bindings for the detected, spawned application can be propagated to the tenant cluster by the domain cluster. A set of RBAC rules for the detected, spawned application can be managed, by the domain cluster, based on the propagated one or more roles and one or more role bindings.

The instructions can additionally, or alternatively, cause the processor to reconcile the one or more applications executing on the tenant cluster. Reconciling the one or more applications executing on the tenant cluster can comprise receiving, by the domain cluster, from the tenant cluster, configuration information for the one or more applications executing on the tenant cluster. A determination can be made by the domain cluster as to whether an application of the one or more applications executing on the tenant cluster has been newly created based on the configuration information for the one or more applications. In response to determining an application of the one or more applications executing on the tenant cluster has been newly created, the newly created application can be represented, by the domain cluster, in the configuration information for the one or more applications executing on the tenant cluster. Another determination can be made by the domain cluster as to whether an application of the one or more applications executing on the tenant cluster has been deleted from the tenant cluster based on the configuration information for the one or more applications. In response to determining an application of the one or more applications executing on the tenant cluster has been deleted from the tenant cluster, the configuration information for the deleted application can be cleaned up by the domain cluster.

According to yet another embodiment, a non-transitory, computer-readable medium can comprise a set of instructions stored therein which, when executed by a processor, causes the processor to support unmodified applications in a multi-tenant, multi-cluster environment by creating, in the multi-tenant, multi-cluster environment, a tenant cluster executing one or more applications, adopting, by a domain cluster of the multi-tenant, multi-cluster environment, the tenant cluster and the one or more applications executing on the tenant cluster without modification to the one or more applications for execution in the multi-tenant, multi-cluster environment and managing, by the domain cluster of the multi-tenant, multi-cluster environment, the tenant cluster and the one or more applications executing on the tenant cluster.

Adopting the tenant cluster and the one or more applications executing on the tenant cluster can comprise installing, by the domain cluster, on the tenant cluster, one or more management software components of the multi-tenant, multi-cluster environment. One or more default projects can be created, by the domain cluster, on the tenant cluster and one or more roles and one or more role bindings can be created, by the domain cluster, for the one or more default projects. The domain cluster can spawn an HNC and a webhook on the tenant cluster. The webhook can comprise a listener for the one or more applications. The domain cluster can detect an existing user namespace on the tenant cluster and generate, on the tenant cluster, one or more custom resources in the detected user namespace. The created one or more roles and one or more role bindings for the created default projects can be propagated to the generated one or more custom resources by the domain cluster. Resource utilization information for the generated one or more custom resources can then be received, by the domain cluster, from the tenant cluster, during execution of the one or more applications on the tenant cluster.

The instructions can additionally, or alternatively, cause the processor to implement one or more multi-namespace projects on the tenant cluster. Implementing the one or more multi-namespace projects on the tenant cluster can comprise spawning, on the tenant cluster, an application in the detected user namespace of the tenant cluster. The spawned application on the tenant cluster can be detected by the domain cluster through the webhook on the tenant cluster. One or more roles and one or more role bindings for the detected, spawned application can be propagated to the tenant cluster by the domain cluster. A set of RBAC rules for the detected, spawned application can be managed, by the domain cluster, based on the propagated one or more roles and one or more role bindings.

The instructions can additionally, or alternatively, cause the processor to reconcile the one or more applications executing on the tenant cluster. Reconciling the one or more applications executing on the tenant cluster can comprise receiving, by the domain cluster, from the tenant cluster, configuration information for the one or more applications executing on the tenant cluster. A determination can be made by the domain cluster as to whether an application of the one or more applications executing on the tenant cluster has been newly created based on the configuration information for the one or more applications. In response to determining an application of the one or more applications executing on the tenant cluster has been newly created, the newly created application can be represented, by the domain cluster, in the configuration information for the one or more applications executing on the tenant cluster. Another determination can be made by the domain cluster as to whether an application of the one or more applications executing on the tenant cluster has been deleted from the tenant cluster based on the configuration information for the one or more applications. In response to determining an application of the one or more applications executing on the tenant cluster has been deleted from the tenant cluster, the configuration information for the deleted application can be cleaned up by the domain cluster.

### BRIEF DESCRIPTION OF THE DRAWINGS

FIG. 1 is a block diagram of a cloud-based architecture according to an embodiment of the present disclosure.

FIG. 2 is a block diagram of an embodiment of the application management server according to one embodiment of the present disclosure

FIG. 3 is a block diagram of a cloud-based architecture according to one embodiment of the present disclosure.

FIG. 4 is a flowchart illustrating an exemplary process for supporting unmodified applications on a tenant cluster according to one embodiment of the present disclosure.

FIG. 5 is a flowchart illustrating additional details of an exemplary process for adopting a tenant cluster according to one embodiment of the present disclosure.

FIG. 6 is a flowchart illustrating additional details of an exemplary process for implementing multi-namespace projects according to one embodiment of the present disclosure.

FIG. 7 is a flowchart illustrating additional details of an exemplary process for performing application reconciliation according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also notable that the terms “comprising”, “including”, and “having” can be used interchangeably.

The term “automatic” and variations thereof may refer to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The term “cluster” may refer to a group of multiple worker nodes that deploy, run and manage containerized or Virtual Machine (VM)-based applications and a master node that controls and monitors the worker nodes. A cluster can have an internal and/or external network address (e.g., Domain Name System (DNS) name or Internet Protocol (IP) address) to enable communication between containers or services and/or with other internal or external network nodes.

The term “container” may refer to a form of operating system virtualization that enables multiple applications to share an operating system by isolating processes and controlling the amount of processing resources (e.g., Central Processing Unit (CPU), Graphics Processing Unit (GPU), etc.), memory, and disk those processes can access. While containers like virtual machines share common underlying hardware, containers, unlike virtual machines they share an underlying, virtualized operating system kernel and do not run separate operating system instances.

The terms “determine”, “calculate” and “compute,” and variations thereof are used interchangeably and include any type of methodology, process, mathematical operation or technique.

The term “deployment” may refer to control of the creation, state and/or running of containerized or VM-based applications. It can specify how many replicas of a pod should run on the cluster. If a pod fails, the deployment may be configured to create a new pod.

The term “domain” may refer to a set of objects that define the extent of all infrastructure under management within a single context. Infrastructure may be physical or virtual, hosted on-premises or in a public cloud. Domains may be configured to be mutually exclusive, meaning there is no overlap between the infrastructure within any two domains.

The term “domain cluster” may refer to the primary management cluster. This may be the first cluster provisioned.

The term “Knative” may refer to a platform that sits on top of containers and enables developers to build a container and run it as a software service or as a serverless function. It can enable automatic transformation of source code into a clone container or functions; that is, Knative may automatically containerize code and orchestrate containers, such as by configuration and scripting (such as generating configuration files, installing dependencies, managing logging and tracing, and writing Continuous Integration/Continuous Deployment (CI/CD) scripts. Knative can perform these tasks through build (which transforms stored source code from a prior container instance into a clone container or function), serve (which runs containers as scalable services and performs configuration and service routing), and event (which enables specific events to trigger container-based services or functions).

The term “master node” may refer to the node that controls and monitors worker nodes. The master node may run a scheduler service that automates when and where containers are deployed based on developer-set deployment requirements and available computing capacity.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “module” may refer to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The term “namespace” may refer to a set of signs (names) that are used to identify and refer to objects of various kinds. In Kubernetes, for example, there are three primary namespaces: default, kube-system (used for Kubernetes components), and kube-public (used for public resources). Namespaces are intended for use in environments with many users spread across multiple teams, or projects. Namespaces may not be nested inside one another, and each Kubernetes resource may be configured to only be in one namespace. Namespaces may provide a way to divide cluster resources between multiple users (via resource quota). The extension of namespaces in the present disclosure is discussed at page 9 of Exhibit “A”. At a high level, the extension to namespaces enables multiple virtual clusters (or namespaces) backed by a common set of physical (Kubernetes) cluster.

The term “pods” may refer to groups of containers that share the same compute resources and the same network.

The term “project” may refer to a set of objects within a tenant that contains applications. A project may act as an authorization target and allow administrators to set policies around sets of applications to govern resource usage, cluster access, security levels, and the like. The project construct can enable authorization (e.g., Role Based Access Control or RBAC), application management, and the like within a project. In one implementation, a project is an extension of Kubernetes' use of namespaces for isolation, resource allocation and basic authorization on a cluster basis. Project may extend the namespace concept by grouping together multiple namespaces in the same cluster or across multiple clusters. Stated differently, projects can run applications on one cluster or on multiple clusters. The resources are allocated per project basis.

The term “project administrator” or “project admin” or PA may refer to the entity or entities responsible for adding members to a project, manages users to a project, manages applications that are part of a project, specifies new policies to be enforced in a project (e.g., with respect to uptime, Service Level Agreements (SLAs), and overall health of deployed applications), etc.

The term “project member” or PM may refer to the entity or entities responsible for deploying applications on Kubernetes in a project, responsible for uptime, SLAs, and overall health of deployed applications. The PM may not have permission to add a user to a project.

The term “project viewer” or PV may refer to the interface that enables a user to view all applications, logs, events, and other objects in a project.

The term “resource”, when used with reference to Kubernetes, may refer to an endpoint in the Kubernetes Application Program Interface (API) that stores a collection of API objects of a certain kind; for example, the built-in pods resource contains a collection of pod objects.

The term “serverless computing” may refer to a way of deploying code that enables cloud native applications to bring up the code as needed; that is, it can scale it up or down as demand fluctuates and take the code down when not in use. In contrast, conventional applications deploy an ongoing instance of code that sits idle while waiting for requests.

The term “service” may refer to an abstraction, which defines a logical set of pods and a policy by which to access them (sometimes this pattern is called a micro-service).

The term “service provider” or SP may refer to the entity that manages the physical/virtual infrastructure in domains. In one implementation, a service provider manages an entire node inventory and tenant provisioning and management. Initially a service provider manages one domain.

The term “service provider persona” may refer to the entity responsible for hardware and tenant provisioning or management.

The term “tenant” may refer to an organizational construct or logical grouping used to represent an explicit set of resources (e.g., physical infrastructure (e.g., CPUs, GPUs, memory, storage, network, and cloud clusters, people, etc.) within a domain. Tenants “reside” within infrastructure managed by a service provider. By default, individual tenants do not overlap or share anything with other tenants; that is, each tenant can be data isolated, physically isolated, and runtime isolated from other tenants by defining resource scopes devoted to each tenant. Stated differently, a first tenant can have a set of resources, resource capabilities, and/or resource capacities that is different from that of a second tenant. Service providers assign worker nodes to a tenant, and the tenant admin forms the clusters from the worker nodes.

The term “tenant administrator” or “tenant admin” or TA may refer to the entity responsible for managing an infrastructure assigned to a tenant. The tenant administrator is responsible for cluster management, project provisioning, providing user access to projects, application deployment, specifying new policies to be enforced in a tenant, etc.

The term “tenant cluster” may refer to clusters of resources assigned to each tenant upon which user workloads run. The domain cluster performs lifecycle management of the tenant clusters.

The term “virtual machine” or “VM” may refer to a server abstracted from underlying computer hardware so as to enable a physical server to run multiple virtual machines or a single virtual machine that spans more than one server. Each virtual machine typically runs its own operating system instance to permit isolation of each application in its own virtual machine, reducing the chance that applications running on common underlying physical hardware will impact each other.

The term “volume” may refer to an ephemeral or persistent volume of memory of a selected size that is created from a distributed storage pool of memory. A volume may comprise a directory on disk and data or in another container and be associated with a volume driver. In some implementations, the volume is a virtual drive and multiple virtual drives can create multiple volumes. When a volume is created, a scheduler may automatically select an optimum node on which to create the volume. A “mirrored volume” refers to synchronous cluster-local data protection while a “replicated volume” refers to asynchronous cross-cluster data protection.

The term “worker node” may refer to the compute resources and network(s) that deploy, run, and manage containerized or VM-based applications. Each worker node contains the services to manage the networker between the containers, communication with the master node, and assign resources to the containers scheduled. Each worker node can include a tool that is used to manage the containers, such as Docker, and a software agent called a Kubelet that receives and executes orders from the master node (e.g., the master API server). The Kubelet is a primary node agent which executes on each worker node inside the cluster. The Kubelet receives the pod specifications through an API server and executes the container associated with the pods and ensures that the containers described in the pods are running and healthy. If Kubelet notices any issues with the pods running on the worker nodes then it tries to restart the pod on the same node and if the issue is with the worker node itself then the master node detects the node failure and decides to recreate the pods on the other healthy node.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

The present disclosure is directed to a multi-cloud platform that can provide a single plane of management console from which customers manage cloud-native applications and clusters and data using a policy-based management framework. The platform can be provided as a hosted service that is either managed centrally or deployed in customer environments. The customers could be enterprise customers or service providers. The platform can manage applications across multiple Kubernetes clusters, which could be residing on-premises or in the cloud or combinations thereof (e.g., hybrid cloud implementations). The platform can provide abstract core networker and storage services on premises and in the cloud for stateful and stateless applications.

According to one embodiment, the platform can be adapted to add tenant clusters to the environment wherein applications executing on the added tenant cluster need not be modified to be supported by the platform, e.g., to continue to execute on the added tenant cluster and be managed by the management plane of the platform. According to one embodiment, supporting such unmodified applications in a multi-tenant, multi-cluster environment can comprise creating, in the multi-tenant, multi-cluster environment, a tenant cluster executing one or more applications. The tenant cluster and the one or more applications executing on the tenant cluster can be adopted by a domain cluster of the multi-tenant, multi-cluster environment without modification to the one or more applications for execution in the multi-tenant, multi-cluster environment. The tenant cluster and the one or more applications executing on the tenant cluster can then be managed by the domain cluster of the multi-tenant, multi-cluster environment. In some cases, the multi-tenant, multi-cluster environment can comprise a Kubernetes environment, for example.

The platform can enable organizations to deliver a high-productivity Platform-as-a-Service (PaaS) that addresses multiple infrastructure-related and operations-related tasks and issues surrounding cloud-native development. It can support many container application platforms besides or in addition to Kubernetes, such as Red Hat, OpenShift, Docker, and other Kubernetes distributions, whether hosted or on-premises.

While this disclosure is discussed with reference to the Kubernetes container platform, it is to be appreciated that the concepts disclosed herein apply to other container platforms, such as Microsoft Azure™, Amazon Web Services™ (AWS), Open Container Initiative (OCI), CoreOS, and Canonical (Ubuntu) LXD™.

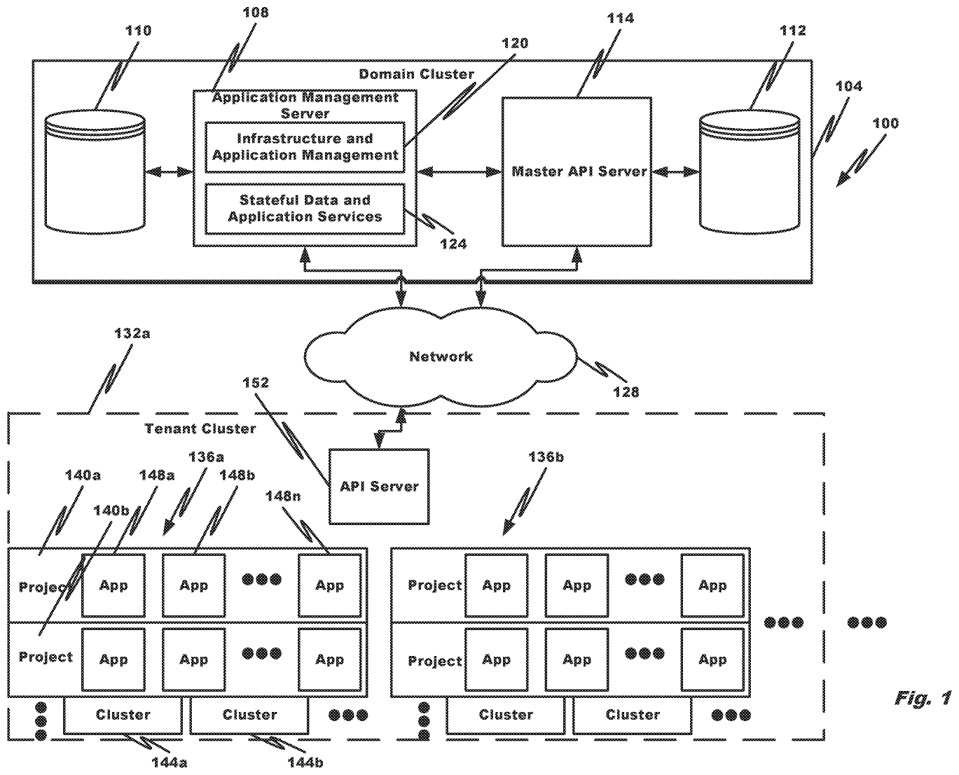

FIG. 1 is a block diagram of a cloud-based architecture according to an embodiment of the present disclosure. As illustrated in this example, a multi-cloud platform 100 can be in communication, via network 128, with one or more tenant clusters 132a, . . . . Each tenant cluster 132a, . . . can correspond to one or multiple tenants 136a, b, . . . , with each of the one or multiple tenants 136a, b, . . . in turn corresponding to a plurality of projects 140a, b, . . . and worker node clusters 144a, b, . . . . Each containerized or VM-based application 148a, b, . . . n in each project 140a, b, . . . can utilize the worker node resources in one or more of the clusters 144a, b, . . . .

To manage the tenant clusters 132a . . . the multi-cloud platform 100 can be associated with a domain cluster 104 and can comprise an application management server 108 and associated data storage 110 and master Application Programming Interface (API) server 114, which can be part of the master node (not shown) and associated data storage 112. The application management server 108 can communicate with an API server 152 assigned to the tenant clusters 132a . . . to manage the associated tenant cluster 132a . . . . In some implementations, each cluster can have a controller or control plane that is different from the application management server 108.

The servers 108 and 114 can be implemented as a physical (or bare-metal) server or cloud server. As will be appreciated, a cloud server is a physical and/or virtual infrastructure that performs application- and information-processing storage. Cloud servers are commonly created using virtualization software to divide a physical (bare metal) server into multiple virtual servers. The cloud server can use Infrastructure-as-a-Service (IaaS) model to process workloads and store information.

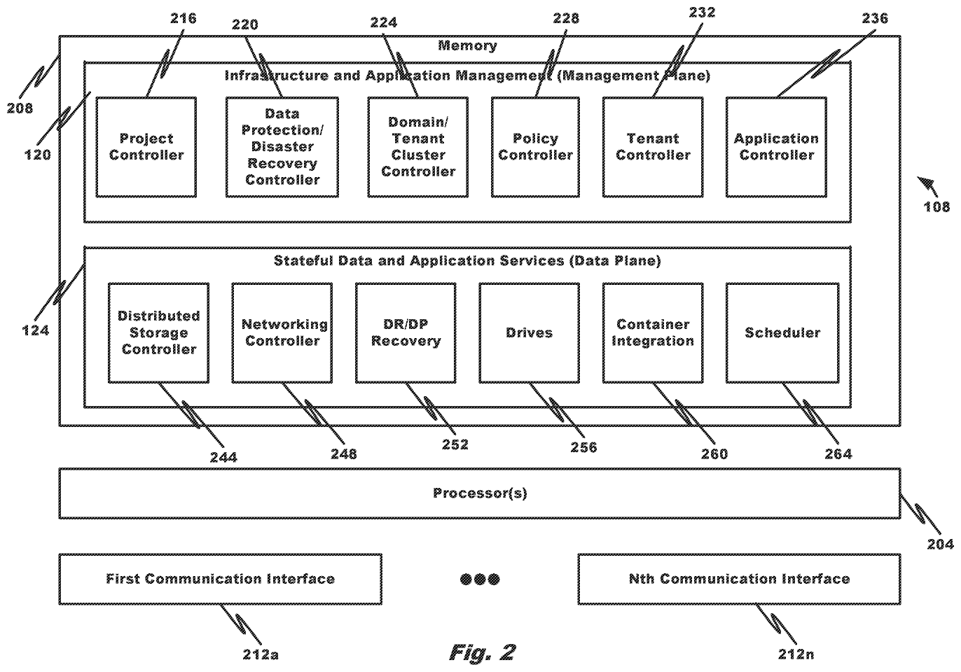

The application management server 108 can perform tenant cluster management using two management planes or levels, namely an infrastructure and application management layer 120 and stateful and application services layer 124. The stateful and application services layer 124 can abstract network and storage resources to provide global control and persistence, span on-premises and cloud resources, and provide intelligent placement of workloads based on logical data locality and block storage capacity. These layers are discussed in detail in connection with FIG. 2.

The API servers 114 and 152, which effectively act as gateways to the clusters, can be commonly each implemented as a Kubernetes API server that implements a RESTful API over HTTP, performs all API operations, and is responsible for storing API objects into a persistent storage backend. Because all of the API server's persistent state is stored in external storage (which is one or both of the databases 110 and 112 in the case of master API server 114) that are typically external to the API server, the server itself is typically stateless and can be replicated to handle request load and provide fault tolerance. The API servers commonly provide API management (the process by which APIs are exposed and managed by the server), request processing (the target set of functionality that processes individual API requests from a client), and provide internal control loops (that provide internals responsible for background operations necessary to the successful operation of the API server).

In one implementation, the API server receives https requests from Kubectl or any automation to send requests to any Kubernetes cluster. Users can access the cluster using API server 152 and it can store the API objects into an etcd data structure. As will be appreciated, etcd is a consistent and highly-available key value store used as Kubernetes' backing store for all cluster data. The master API server 114 can receive https requests from user interface (UI) or dmctl. This provides a single endpoint of contact for all UI functionality. It typically validates the request and sends the request to the API server 152. An agent controller (not shown) can reside on each tenant cluster and perform actions in each cluster. Domain cluster components can use Kubernetes native or CustomResourceDefinitions (CRD) objects to communicate with the API server 152 in the tenant cluster. The agent controller can handle the CRD objects.

In one implementation, the tenant clusters can run controllers such as an HNC controller, storage agent controller, or agent controller. The communication between domain cluster components and tenant cluster can be via the API server 152 on the tenant clusters. The applications on the domain cluster 104 can communicate with applications 148 on tenant clusters 144 and the applications 148 on one tenant cluster 144 can communicate with applications 148 on another tenant cluster 144 to implement specific functionality.

Data storage 110 is normally configured as a database and stores data structures necessary to implement the functions of the application management server 108. For example, data storage 110 comprises objects and associated definitions corresponding to each tenant cluster 144, and project and references to the associated cluster definitions in data storage 112. Other objects/definitions include networks and endpoints (for data networks), volumes (created from a distributed data storage pool on demand), mirrored volumes (created to have mirrored copies on one or more other nodes), snapshot volumes (a point-in-time image of a corresponding set of volume data), linked clones (volumes created from snapshot volumes are called linked clones of the parent volume and share data blocks with the corresponding snapshot volume until the linked clone blocks are modified), namespaces, access permissions and credentials, and other service-related objects.

Namespaces enable the use of multiple virtual clusters backed by a common physical cluster. The virtual clusters can be defined by namespaces. Names of resources are unique within a namespace but not across namespaces. In this manner, namespaces allow division of cluster resources between multiple uses. Namespaces are also used to manage access to application and service-related Kubernetes objects, such as pods, services, replication, controllers, deployments, and other objects that are created in namespaces.

Data storage 112 can include the data structures enabling cluster management by the master API server 114. In one implementation, data storage 112 can be configured as a distributed key-value lightweight database, such as an etcd key value store. In Kubernetes, it is a central database for storing the current cluster state at any point in time and also used to store the configuration details such as subnets, configuration maps, etc.

The communication network 128, in some embodiments, can be any trusted or untrusted computer network, such as a WAN or LAN. The Internet is an example of the communication network 128 that constitutes an IP network consisting of many computers, computing networks, and other communication devices located all over the world. Other examples of the communication network 128 include, without limitation, an Integrated Services Digital Network (ISDN), the Public Switched Telephone Network (PSTN), a cellular network, and any other type of packet-switched or circuit-switched network known in the art. In some embodiments, the communication network 128 may be administered by a Mobile Network Operator (MNO). It should be appreciated that the communication network 128 need not be limited to any one network type, and instead may be comprised of a number of different networks and/or network types. Moreover, the communication network 128 may comprise a number of different communication media such as coaxial cable, copper cable/wire, fiber-optic cable, antennas for transmitting/receiving wireless messages, wireless access points, routers, and combinations thereof.

With reference now to FIG. 2, additional details of the application management server 108 will be described in accordance with embodiments of the present disclosure. The server 108 is shown to include processor(s) 204, memory 208, and communication interfaces 212a . . . n. These resources may enable functionality of the server 108 as will be described herein.

The processor(s) 204 can correspond to one or many computer processing devices. For instance, the processor(s) 204 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor(s) 204 may be provided as a microcontroller, microprocessor, Central Processing Unit (CPU), or plurality of microprocessors that are configured to execute the instructions sets stored in memory 208. Upon executing the instruction sets stored in memory 208, the processor(s) 204 enable various centralized management functions over the tenant clusters.

The memory 208 may include any type of computer memory device or collection of computer memory devices. The memory 208 may include volatile and/or non-volatile memory devices. Non-limiting examples of memory 208 include Random-Access Memory (RAM), Read-Only Memory (ROM), flash memory, Electronically-Erasable Programmable ROM (EEPROM), Dynamic RAM (DRAM), etc. The memory 208 may be configured to store the instruction sets depicted in addition to temporarily storing data for the processor(s) 204 to execute various types of routines or functions.

The communication interfaces 212a . . . n may provide the server 108 with the ability to send and receive communication packets (e.g., requests) or the like over the network 128. The communication interfaces 212a . . . n may be provided as a Network Interface Card (MC), a network port, drivers for the same, and the like. Communications between the components of the server 108 and other devices connected to the network 128 may all flow through the communication interfaces 212a . . . n. In some embodiments, the communication interfaces 212a . . . n may be provided in a single physical component or set of components, but may correspond to different communication channels (e.g., software-defined channels, frequency-defined channels, amplitude-defined channels, etc.) that are used to send/receive different communications to the master API server 112 or API server 152.

The illustrative instruction sets that may be stored in memory 208 include, without limitation, in the infrastructure and application management (management plane) 124, the project controller 216, data protection/disaster recovery controller 220, domain/tenant cluster controller 224, policy controller 228, tenant controller 232, and application controller 236 and, in the stateful data and application services (data plane) 124, distributed storage controller 244, networker controller 248, Data Protection (DP)/Disaster Recovery (DR) 252, logical and physical drives 256, container integration 260, and scheduler 264. Functions of the application management server 108 enabled by these various instruction sets are described below. Although not depicted, the memory 208 may include instructions that enable the processor(s) 204 to store data into and retrieve data from data storage 110 and 112.

It should be appreciated that the instruction sets depicted in FIG. 2 may be combined (partially or completely) with other instruction sets or may be further separated into additional and different instruction sets, depending upon configuration preferences for the server 108. Said another way, the particular instruction sets depicted in FIG. 2 should not be construed as limiting embodiments described herein.

In some embodiments, the instructions for the project controller 216, when executed by processor(s), may enable the server 108 to control, on a project-by-project basis, the resource utilization based on project members and control things such as authorization of resources within a project or across other projects using a network access control list (ACL) policies. The project causes grouping of resources such as memory, CPU, storage and network and quota of these resources. The project members view or consume resources based on authorization policies. The projects could be on only one cluster or span across multiple or different clusters.

In some embodiments, instructions for the application mobility and disaster recovery controller 220 (at the management plane) and the data protection disaster recovery/DP 252 (at the data plane), when executed by processor(s), may enable the server 108 to implement containerized or VM-based application migration from one cluster to another cluster using migration agent controllers on individual clusters.

In some embodiments, the instructions for the domain/tenant cluster controller 224, when executed by processor(s), may enable the server 108 to control provisioning of cloud-specific clusters and manage their native Kubernetes clusters. Other cluster operations that can be controlled include adopting an existing cluster, removing the cluster from the server 108, upgrading a cluster, creating the cluster, and destroying the cluster.

In some embodiments, instructions for the policy controller 228, when executed by the processor(s), may enable the server 108 to effect policy-based management, whose goal is to capture user intent via templates and enforce them declaratively for different applications, nodes, and clusters. An application may specify a policy for an application or storage. The policy controller 228 can manage policy definitions and propagate them to individual clusters. The policy controller 228 can interpret the policies and give the policy enforcement configuration to corresponding feature specific controllers. The policy controller 228 could be run at the tenant cluster or at the master node based on functionality.

According to one embodiment, the policy controller 228 can define a plurality of user roles. Each user role of the plurality of user roles can have a defined access permission for one or more resource objects on one or more tenant clusters of the multi-tenant, multi-cluster environment as may be provided by multi-cloud platform 100. In response to receiving a request from a user to access the multi-tenant, multi-cluster environment the policy controller 228 can determine a user role for the user based on the request. Determining the user role for the user can comprise authenticating and authorizing the user and providing a token in response to the request can be performed in response to authenticating the user. In some implementations, user management and authentication and authorization may be performed by a third-party service provider such as HashiCorp Vault, for example.

Other examples of policy control include application policy management (e.g., containerized or VM-based application placement, failover, migration, and dynamic resource management), storage policy management (e.g., storage policy management controls the snapshot policy, backup policy, replication policy, encryption policy, etc. for an application), network policy management, security policies, performance policies, access control lists, and policy updates.

In some embodiments, instructions for the application controller 236, when executed by the processor(s), may enable the server 108 to deploy applications, effect application failover/fallback, application cloning, cluster cloning, and monitoring applications. In one implementation, the application controller enables users to launch their applications from the server 108 on individual clusters or a set of clusters using a Kubectl command.

In some embodiments, the instructions for the networker controller 248, when executed by processor(s), may enable the server 108 to enable multi-cluster or container networker (particularly at the data link and network layers) in which services or applications run mostly on one cluster and, for high availability reasons, use another cluster either on premises or on the public cloud. The service or application can migrate to other clusters upon user request or for other reasons. In most implementations, services run in one cluster at a time. The network controller 248 can also enable services to use different clusters simultaneously and enable communication across the clusters. The networker controller 248 can attach one or more interfaces (programmed to have a specific performance configuration) to a selected container while maintaining isolation between management and data networks. This can be done by each container having the ability to request one or more interfaces on specified data networks.

In some embodiments, the instructions for the logical drives 408a-n when executed by processor(s), may enable the server 108 to provide a common API (via the Container Networker Interface) for connecting containers to an external network and expose (via the Container Storage Interface (CSI)) arbitrary block and file storage systems to containerized or VM-based workloads. In some implementations, CSI can expose arbitrary block and file storage systems to containerized workloads on Container Orchestration Systems (COs), such as Kubernetes and AWS.

In some embodiments, the instructions for the container integration 260, when executed by processor(s), may enable the server 108 to provide (via OpenShift) a cloud-based container platform that is both containerization software and a platform-as-a-service (PaaS).

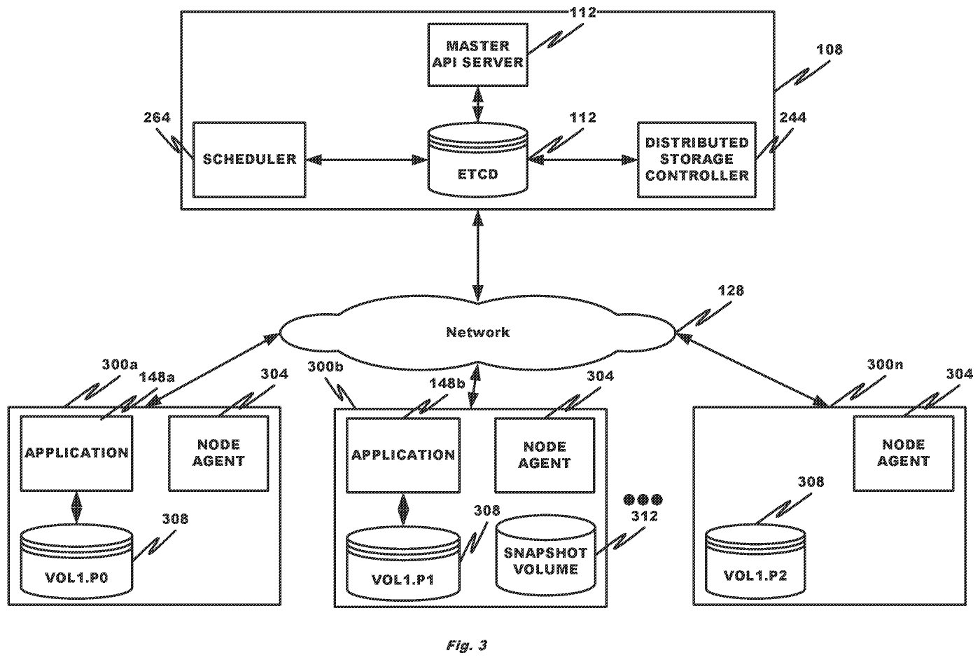

FIG. 3 illustrates the operations of the scheduler 264 and distributed storage controller 244 in more detail. The application server 108 is in communication, via network 128, with a plurality of worker nodes 300a-n. While FIG. 3 depicts the master API server separate from the worker nodes, in some implementations the same node can act as both a master and worker node.

The database 112 is depicted as an “/etc distributed” or etcd key value store that stores physical data as key-value pairs in a persistent b+tree. Each revision of the etcd key value store's state typically contains only the delta from a previous revision for storage efficiency. A single revision may correspond to multiple keys in the tree. The key of a key-value pair is a 3-tuple (major, sub, type). The database 112, in this implementation, stores the entire state of a cluster: that is, it stores the cluster's configuration, specifications, and the statuses of the running workloads. In Kubernetes in particular, etcd's “watch” function monitor the data and reconfigures itself when changes occur.

The worker nodes 300a-n can be part of a common cluster or different clusters 144, the same or different projects 140, and/or the same or different tenant clusters 132, depending on the implementation. The worker nodes 300 comprise the compute resources, drives on which volumes are created for applications, and network(s) that deploy, run, and manage containerized or VM-based applications. For example, a first worker node 300a comprises an application 148a, a node agent 304, and a database 308 containing storage resources. The node agent 304, or Kubelet in Kubernetes, runs on each worker node and ensures that all containers are running and healthy in a pod and makes any configuration changes on the worker nodes. The database 308 or other data storage resource corresponds to the pod associated with the worker node (e.g., the database 308 for first worker node 300a is identified as “P0” for pod 0, the database 308 for the second worker node 300b is identified as “P1” for pod 1, and the database 308 for the nth worker node 300n is identified as “P2” for pod 2. Each database 308 in the first and second worker nodes 300a and b is shown to include a volume associated with respective application 148a and b. The volume in the nth worker node 300n, depending on the implementation, could be associated with either of the applications 148a orb. As will be appreciated, an application's volume can be divided among the storage resources of multiple worker nodes and is not limited to the storage resources of the worker node running the application.

The master API server 112, in response to user requests to instantiate an application or create an application or snapshot 312 volume, records the request in the etcd database 112, and, in response, the scheduler 264 determines on which database (s) 308 the volume should be created in accordance with placement polices specified by the policy controller 228. For example, the placement policy can select the worker node having the least amount of storage resources consumed at that point, that is required for optimal operation of the selected application 148, or that is selected by the user.

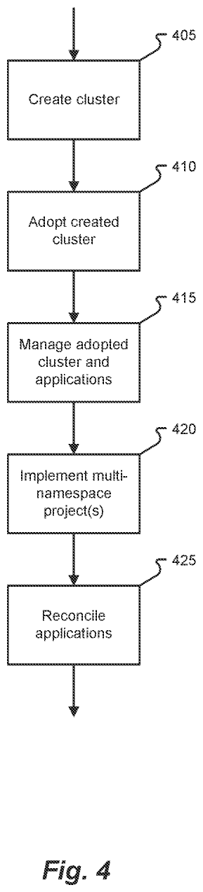

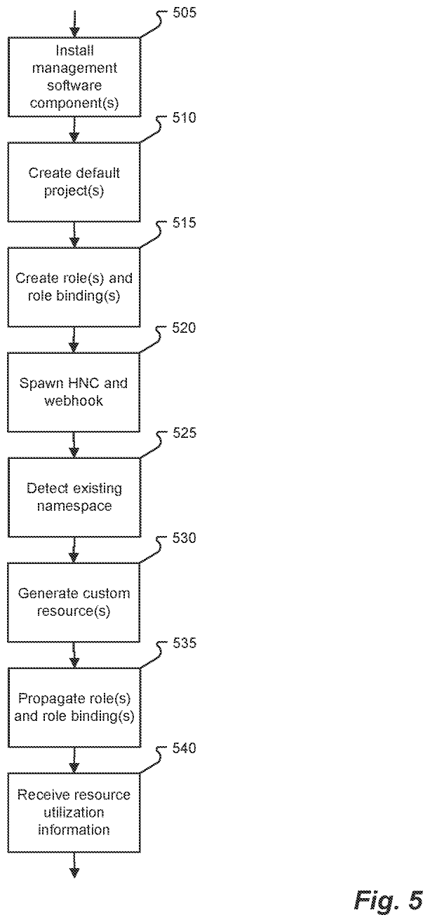

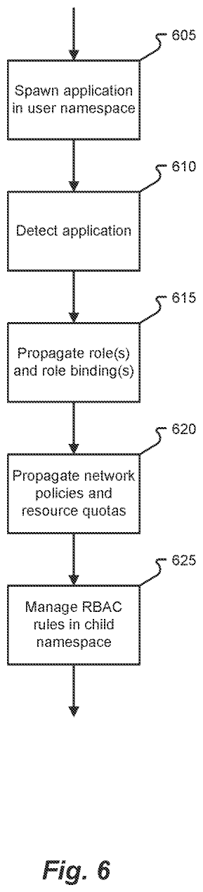

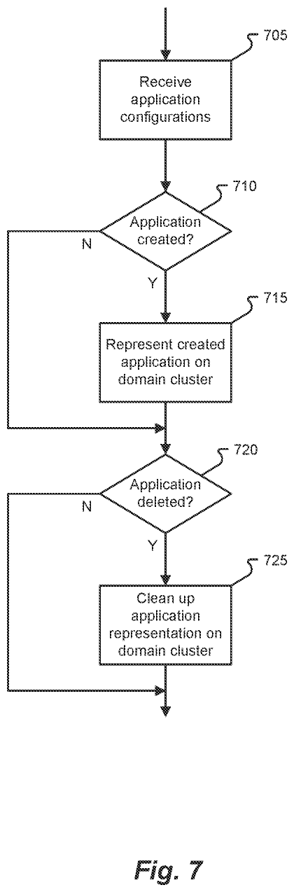

FIG. 4 is a flowchart illustrating an exemplary process for supporting unmodified applications on a tenant cluster according to one embodiment of the present disclosure. As illustrated in this example, supporting unmodified applications in a multi-tenant, multi-cluster environment, such as multi-cloud platform 100 described above, can comprise creating 405, in the multi-tenant, multi-cluster environment, a tenant cluster 144 executing one or more applications 148. The tenant cluster 144 and the one or more applications 148 executing on the tenant cluster 144 can be adopted 410 by a domain cluster 104 of the multi-tenant, multi-cluster environment without modification to the one or more applications 148 for execution in the multi-tenant, multi-cluster environment. An exemplary process for adopting a tenant cluster 144 and applications executing thereon will be described in greater detail below with reference to FIG. 5. The tenant cluster 144 and the one or more applications 148 executing on the tenant cluster 144 can then be managed 415 by the domain cluster 104 of the multi-tenant, multi-cluster environment. In some cases, the multi-tenant, multi-cluster environment can comprise a Kubernetes environment, for example. Additionally, or alternatively, one or more multi-namespace projects can be implemented on the tenant cluster 144 by the domain cluster 104. An exemplary process for implementing multi-namespace projects on a tenant cluster 144 will be described in greater detail below with reference to FIG. 6. Additionally, or alternatively, the domain cluster 104 can reconcile the one or more applications 148 executing on the tenant cluster 144. An exemplary process for reconciling applications executing on a tenant cluster 144 will be described in greater detail below with reference to FIG. 7.

FIG. 5 is a flowchart illustrating additional details of an exemplary process for adopting a tenant cluster according to one embodiment of the present disclosure. As illustrated in this example, adopting the tenant cluster 144 and the one or more applications 148 executing on the tenant cluster 144 can comprise installing 505, by the domain cluster 104, on the tenant cluster 144, one or more management software components of the multi-tenant, multi-cluster environment, such as node agent 304 described above. One or more default projects can be created 510, by the domain cluster 104, on the tenant cluster 144 and one or more roles and one or more role bindings can be created 515, by the domain cluster 104, for the one or more default projects. The domain cluster 104 can spawn 520 an HNC and a webhook on the tenant cluster 144, e.g., within or through node agent 304. The webhook can comprise a listener for the one or more applications 148. The domain cluster 104 can detect 525 an existing user namespace on the tenant cluster 144 and generate 530, on the tenant cluster 144, one or more custom resources in the detected user namespace. The created one or more roles and one or more role bindings for the created default projects can be propagated 535 to the generated one or more custom resources by the domain cluster 104. Resource utilization information for the generated one or more custom resources can then be received 540, by the domain cluster 104, from the tenant cluster 144, during execution of the one or more applications 148 on the tenant cluster 144.

FIG. 6 is a flowchart illustrating additional details of an exemplary process for implementing multi-namespace projects according to one embodiment of the present disclosure. As illustrated in this example, implementing the one or more multi-namespace projects on the tenant cluster 144 can comprise spawning 605, on the tenant cluster 144, an application in the detected user namespace of the tenant cluster 144. The spawned application on the tenant cluster 144 can be detected 610 by the domain cluster 104 through the webhook on the tenant cluster 144. One or more roles and one or more role bindings for the detected, spawned application can be propagated 620 to the tenant cluster 144 by the domain cluster 104. A set of RBAC rules for the detected, spawned application can be managed 625, by the domain cluster 104, based on the propagated one or more roles and one or more role bindings.

FIG. 7 is a flowchart illustrating additional details of an exemplary process for performing application reconciliation according to one embodiment of the present disclosure. As illustrated in this example, reconciling the one or more applications 148 executing on the tenant cluster 144 can comprise receiving 705, by the domain cluster 104, from the tenant cluster 144, configuration information for the one or more applications 148 executing on the tenant cluster 144. A determination 710 can be made by the domain cluster 104 as to whether an application of the one or more applications 148 executing on the tenant cluster 144 has been newly created based on the configuration information for the one or more applications 148. In response to determining 710 an application of the one or more applications 148 executing on the tenant cluster 144 has been newly created, the newly created application can be represented 715, by the domain cluster 104, in the configuration information for the one or more applications 148 executing on the tenant cluster 144. Another determination 720 can be made by the domain cluster 104 as to whether an application of the one or more applications 148 executing on the tenant cluster 144 has been deleted from the tenant cluster 144 based on the configuration information for the one or more applications 148. In response to determining 720 an application of the one or more applications 148 executing on the tenant cluster 144 has been deleted from the tenant cluster 144, the configuration information for the deleted application can be cleaned up 725 by the domain cluster 104.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for supporting unmodified applications in a multi-tenant, multi-cluster environment, the method comprising:
creating, in the multi-tenant, multi-cluster environment, a tenant cluster executing one or more applications;
adopting, by a domain cluster of the multi-tenant, multi-cluster environment, the tenant cluster and the one or more applications executing on the tenant cluster without modification to the one or more applications for execution in the multi-tenant, multi-cluster environment; and
managing, by the domain cluster of the multi-tenant, multi-cluster environment, the tenant cluster and the one or more applications executing on the tenant cluster.

2. The method of claim 1, wherein adopting the tenant cluster and the one or more applications executing on the tenant cluster comprises:
installing, by the domain cluster, on the tenant cluster, one or more management software components of the multi-tenant, multi-cluster environment;
creating, by the domain cluster, on the tenant cluster, one or more default projects;
creating, by the domain cluster, one or more roles and one or more role bindings for the one or more default projects;
spawning, by the domain cluster, on the tenant cluster, a Hierarchical Namespace Controller (HNC) and a webhook, the webhook comprising a listener for the one or more applications;
detecting, by the domain cluster, an existing user namespace on the tenant cluster;
generating, by the domain cluster, on the tenant cluster, one or more custom resources in the detected user namespace on the tenant cluster;
propagating, by the domain cluster, the created one or more roles and one or more role bindings for the created default projects to the generated one or more custom resources; and
receiving, by the domain cluster, from the tenant cluster, resource utilization information for the generated one or more custom resources during execution of the one or more applications on the tenant cluster.

3. The method of claim 2, further comprising implementing, by the domain cluster, one or more multi-namespace projects on the tenant cluster.

4. The method of claim 3, wherein implementing the one or more multi-namespace projects on the tenant cluster comprises:
spawning, on the tenant cluster, an application in the detected user namespace of the tenant cluster;
detecting, by the domain cluster through the spawned webhook on the tenant cluster, the spawned application on the tenant cluster;
propagating, by the domain cluster to the tenant cluster, one or more roles and one or more role bindings for the detected, spawned application; and
managing, by the domain cluster, a set of Role-Based Access Control (RBAC) rules for the detected, spawned application based on the propagated one or more roles and one or more role bindings.

5. The method of claim 2, further comprising reconciling, by the domain cluster, the one or more applications executing on the tenant cluster.

6. The method of claim 5, wherein reconciling the one or more applications executing on the tenant cluster comprises:
receiving, by the domain cluster, from the tenant cluster, configuration information for the one or more applications executing on the tenant cluster;
determining, by the domain cluster, whether an application of the one or more applications executing on the tenant cluster has been newly created based on the configuration information for the one or more applications;
in response to determining an application of the one or more applications executing on the tenant cluster has been newly created, representing, by the domain cluster, the newly created application in the configuration information for the one or more applications executing on the tenant cluster;
determining, by the domain cluster, whether an application of the one or more applications executing on the tenant cluster has been deleted from the tenant cluster based on the configuration information for the one or more applications; and
in response to determining an application of the one or more applications executing on the tenant cluster has been deleted from the tenant cluster, cleaning up, by the domain cluster, the configuration information for the deleted application.

7. The method of claim 1, wherein the multi-tenant, multi-cluster environment comprises a Kubernetes environment.

8. A multi-tenant, multi-cluster environment comprising:
a domain cluster communicatively coupled with each of the plurality of tenant clusters, the domain cluster comprising a processor and a memory coupled with and readable by the processor and storing therein a set of instructions which, when executed by the processor, causes the processor to:
adopt a created tenant cluster and one or more applications executing on the tenant cluster without modification to the one or more applications for execution in the multi-tenant, multi-cluster environment; and
manage the tenant cluster and the one or more applications executing on the tenant cluster.

9. The multi-tenant, multi-cluster environment of claim 8, wherein adopting the tenant cluster and the one or more applications executing on the tenant cluster comprises:
install, on the tenant cluster, one or more management software components of the multi-tenant, multi-cluster environment;
create, on the tenant cluster, one or more default projects;
create one or more roles and one or more role bindings for the one or more default projects;
spawn on the tenant cluster, a Hierarchical Namespace Controller (HNC) and a webhook, the webhook comprising a listener for the one or more applications;
detect an existing user namespace on the tenant cluster;
generate, on the tenant cluster, one or more custom resources in the detected user namespace on the tenant cluster;
propagate the created one or more roles and one or more role bindings for the created default projects to the generated one or more custom resources; and
receive, from the tenant cluster, resource utilization information for the generated one or more custom resources during execution of the one or more applications on the tenant cluster.

10. The multi-tenant, multi-cluster environment of claim 9, wherein the instructions further cause the processor to implement one or more multi-namespace projects on the tenant cluster.

11. The multi-tenant, multi-cluster environment of claim 10, wherein implementing the one or more multi-namespace projects on the tenant cluster comprises:
spawning, on the tenant cluster, an application in the detected user namespace of the tenant cluster;
detecting, through the spawned webhook on the tenant cluster, the spawned application on the tenant cluster;
propagating, to the tenant cluster, one or more roles and one or more role bindings for the detected, spawned application; and
managing a set of Role-Based Access Control (RBAC) rules for the detected, spawned application based on the propagated one or more roles and one or more role bindings.

12. The multi-tenant, multi-cluster environment of claim 9, wherein the instructions further cause the processor to reconcile the one or more applications executing on the tenant cluster.

13. The multi-tenant, multi-cluster environment of claim 12, wherein reconciling the one or more applications executing on the tenant cluster comprises:
receiving, from the tenant cluster, configuration information for the one or more applications executing on the tenant cluster;
determining whether an application of the one or more applications executing on the tenant cluster has been newly created based on the configuration information for the one or more applications;
in response to determining an application of the one or more applications executing on the tenant cluster has been newly created, representing the newly created application in the configuration information for the one or more applications executing on the tenant cluster;
determining whether an application of the one or more applications executing on the tenant cluster has been deleted from the tenant cluster based on the configuration information for the one or more applications; and
in response to determining an application of the one or more applications executing on the tenant cluster has been deleted from the tenant cluster, cleaning up the configuration information for the deleted application.

14. The multi-tenant, multi-cluster environment of claim 8, wherein the multi-tenant, multi-cluster environment comprises a Kubernetes environment.

15. A non-transitory, computer-readable medium comprising a set of instructions stored therein which, when executed by a processor, causes the processor to support unmodified applications in a multi-tenant, multi-cluster environment by:
creating, in the multi-tenant, multi-cluster environment, a tenant cluster executing one or more applications;
adopting, by a domain cluster of the multi-tenant, multi-cluster environment, the tenant cluster and the one or more applications executing on the tenant cluster without modification to the one or more applications for execution in the multi-tenant, multi-cluster environment; and
managing, by the domain cluster of the multi-tenant, multi-cluster environment, the tenant cluster and the one or more applications executing on the tenant cluster.

16. The non-transitory, computer-readable medium of claim 15, wherein adopting the tenant cluster and the one or more applications executing on the tenant cluster comprises:
installing, by the domain cluster, on the tenant cluster, one or more management software components of the multi-tenant, multi-cluster environment;
creating, by the domain cluster, on the tenant cluster, one or more default projects;
creating, by the domain cluster, one or more roles and one or more role bindings for the one or more default projects;
spawning, by the domain cluster, on the tenant cluster, a Hierarchical Namespace Controller (HNC) and a webhook, the webhook comprising a listener for the one or more applications;
detecting, by the domain cluster, an existing user namespace on the tenant cluster;
generating, by the domain cluster, on the tenant cluster, one or more custom resources in the detected user namespace on the tenant cluster;
propagating, by the domain cluster, the created one or more roles and one or more role bindings for the created default projects to the generated one or more custom resources; and
receiving, by the domain cluster, from the tenant cluster, resource utilization information for the generated one or more custom resources during execution of the one or more applications on the tenant cluster.

17. The non-transitory, computer-readable medium of claim 16, further comprising implementing, by the domain cluster, one or more multi-namespace projects on the tenant cluster.

18. The non-transitory, computer-readable medium of claim 17, wherein implementing the one or more multi-namespace projects on the tenant cluster comprises:
spawning, on the tenant cluster, an application in the detected user namespace of the tenant cluster;
detecting, by the domain cluster through the spawned webhook on the tenant cluster, the spawned application on the tenant cluster;
propagating, by the domain cluster to the tenant cluster, one or more roles and one or more role bindings for the detected, spawned application; and
managing, by the domain cluster, a set of Role-Based Access Control (RBAC) rules for the detected, spawned application based on the propagated one or more roles and one or more role bindings.

19. The non-transitory, computer-readable medium of claim 16, further comprising reconciling, by the domain cluster, the one or more applications executing on the tenant cluster.

20. The non-transitory, computer-readable medium of claim 19, wherein reconciling the one or more applications executing on the tenant cluster comprises:
receiving, by the domain cluster, from the tenant cluster, configuration information for the one or more applications executing on the tenant cluster;
determining, by the domain cluster, whether an application of the one or more applications executing on the tenant cluster has been newly created based on the configuration information for the one or more applications;
in response to determining an application of the one or more applications executing on the tenant cluster has been newly created, representing, by the domain cluster, the newly created application in the configuration information for the one or more applications executing on the tenant cluster;
determining, by the domain cluster, whether an application of the one or more applications executing on the tenant cluster has been deleted from the tenant cluster based on the configuration information for the one or more applications; and
in response to determining an application of the one or more applications executing on the tenant cluster has been deleted from the tenant cluster, cleaning up, by the domain cluster, the configuration information for the deleted application.
